(19) United States
(12) Patent Application Publication
(10) Pub. No.: US 2015/0181797 A1
(43) Pub. Date: Jul. 2, 2015

(54) AGRICULTURAL DISCING APPARATUS HAVING BIFOLD WING SECTIONS AND METHOD FOR FORMING SAME

(71) Applicant: Daniel L. Abbott, Edmore, MI (US)

(72) Inventor: Daniel L. Abbott, Edmore, MI (US)

(21) Appl. No.: 14/144,690

(22) Filed: Dec. 31, 2013

(51) Int. Cl. A01B 73/04

(52) U.S. Cl. CPC A01B 73/046

(57) ABSTRACT

An agricultural discing apparatus having bifold wing assemblies includes a center section and a plurality of winged assemblies attached to the center section. Each of the plurality of winged sections includes an inner wing and an outer wing which folds upon itself when in a retracted position. The outer wing section is supported without the use of a wheel assembly directly under the outer wing and is supported solely by a plurality of block members attached to the inner wing. The plurality of winged sections folds inwardly upon one another when in the retracted position. Finally, a plurality of retractable support wheels attached to the rear of the center section are used for use in distributing the load of the agricultural discing apparatus in transport.

### FIELD OF THE INVENTION

The present invention relates generally to an agricultural disc apparatus and more specifically to a disc apparatus having bifold wing sections.

### BACKGROUND

Discing machines are used in agricultural applications for providing a furrow for seed planting. Prior art FIG. 1 illustrates a discing machine made by Landoll Corporation. Sunflower Corporation, Krause Corporation and John Deere, Inc. all make their own version of the disc machine. The discing machine is typically pulled behind an agricultural vehicle such as a tractor or the like so as to “fit” the plowed field. The terming “fit” or “fitting” the field means to smooth and/or remove as many as the bumps and imperfections as possible. This gives earth in the field a substantially flat and smooth surface that has no holes or voids that would hinder crop growth. Since the key to effective planting is seed-to-ground contact, it is important that a furrow be created so a seed can be planted at a precise depth. This enables the seed to grow and mature in a minimal time for harvest. Discing differs from plowing in that the earth is rolled underneath itself rather than just making a furrowed groove in the soil.

As seen in FIG. 1, the discing machine 100 includes a center section 101, a first side section 103 and a second side section 105. A first front disc 107 and second front disc 108 are angularly positioned forward of the center section 101, first side section 103 and second side section 105 while a first rear disc 109 and second rear disc (not shown) are angularly positioned rearward of the center section 101. In use, the front discs and rear disc work to smooth the earth and create a furrow for planting seed at a precision depth.

In order to fit a high acreage field in a short time, a longer front disc and rear disc are more preferable. This enables the farmer and/or operator of this equipment to cover a much wider land area. This also enables the field to be “fit” for planting in the shortest time possible. However, those skilled in the art will recognize that the wider and longer the front and rear disc, the more difficult this equipment is to transport. The two outer sections of the disc can generally be folded vertically about a center section using hydraulics. However, there is typically a practical limit on how wide a front and rear disc that can be used since the disc when folded vertically can be taller than telephone or electrical wires. FIG. 2 illustrates a front view of a discing machine 201 with its wing sections retracted for transport as used in the prior art. Typically, the maximum not to exceed height (ground to top of discing machine) will be approximately 14 ft-11 in. in order to avoid overhead roadway obstacles. If the disc is too tall, it cannot be moved any distance where it might encounter lower hanging wires. Moreover, the size and weight of this vertically folded structure can be dangerous in the event that hydraulics were to fail and/or alternatively a “pin” used to hold the structure together were to break. If either or both sides of the disc were to fall, it can severely damage and/or destroy the disc because of its mass. Consequently, a new discing apparatus is needed to avoid these problems.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a front perspective view of a discing machine as used in the prior art.

FIG. 2 illustrates a front view of a discing machine with its wing sections retracted for transport as used in the prior art.

FIG. 3 illustrates a front perspective view showing an improved discing apparatus having bifold wings in accordance with an embodiment of the invention.

FIG. 4A illustrates a close-up view of the block support system in accordance with an embodiment of the invention.

FIG. 4B illustrates a magnified view of the block support system as shown in FIG. 4A.

FIG. 5 illustrates a rear perspective view of the discing machine with its bifold wing section extended in accordance with an embodiment of the invention.

FIG. 6 illustrates a front view of a bifold wing section being retracted in accordance with an embodiment of the invention.

FIG. 7 illustrates a front view of the discing machine where both bifold wing sections are partially folded inwardly toward one another.

FIG. 8 illustrates a rear view of the discing machine where both the bifold wing sections are fully folded inwardly for transport.

FIG. 9 illustrates a rear view of the transport wheels in a downward position to support the load of the discing machine on a roadway.

FIG. 10 illustrates a rear view of the transport while in a retracted position when the discing machine is pulled though a field.

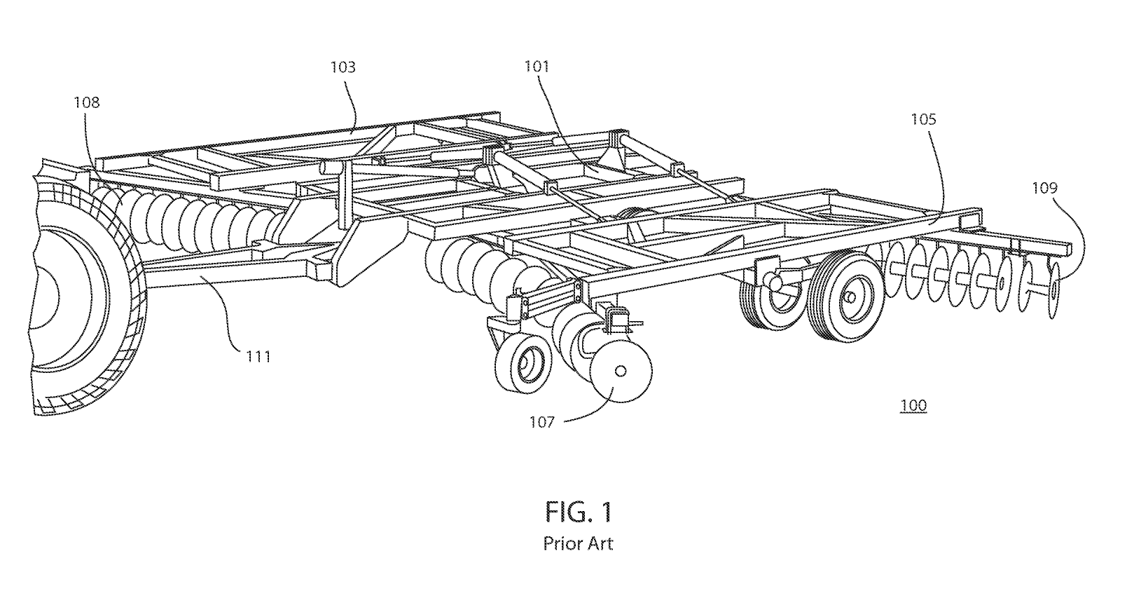

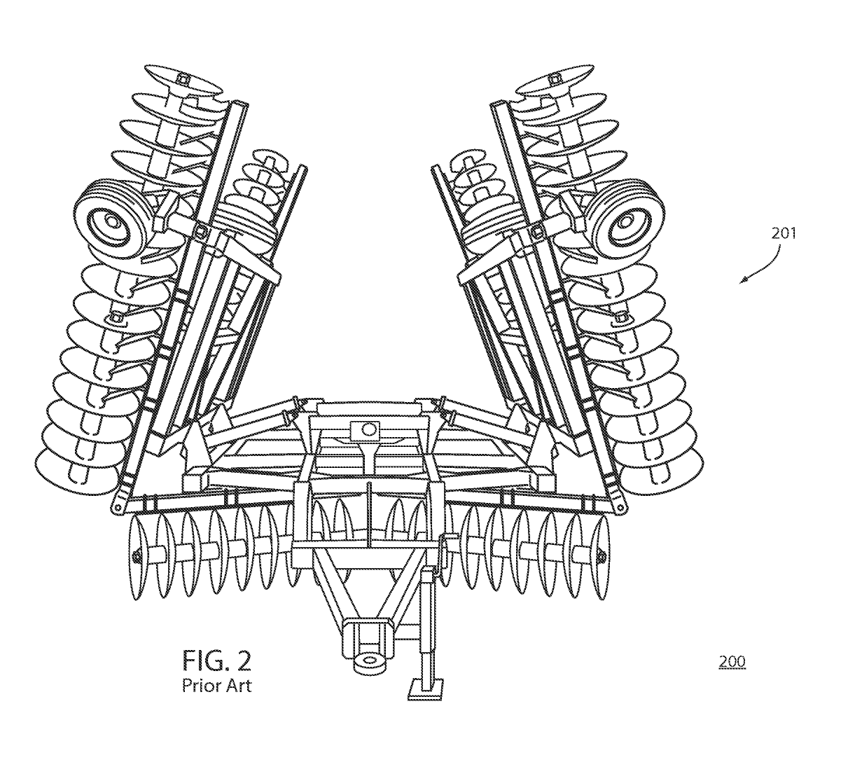

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to an agricultural discing machine. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

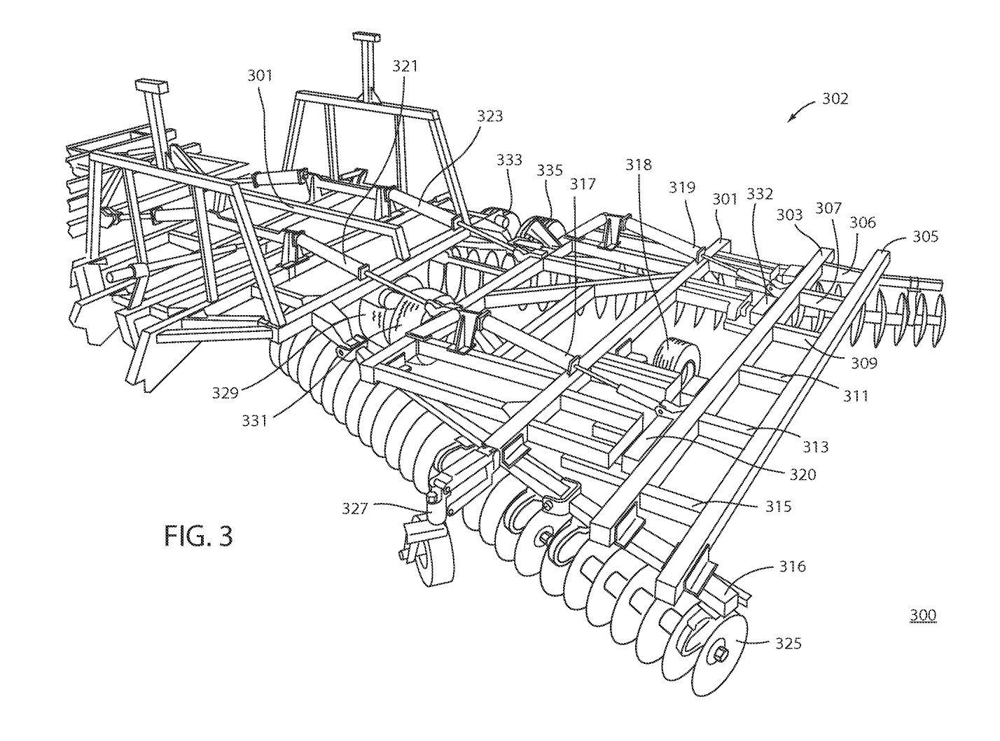

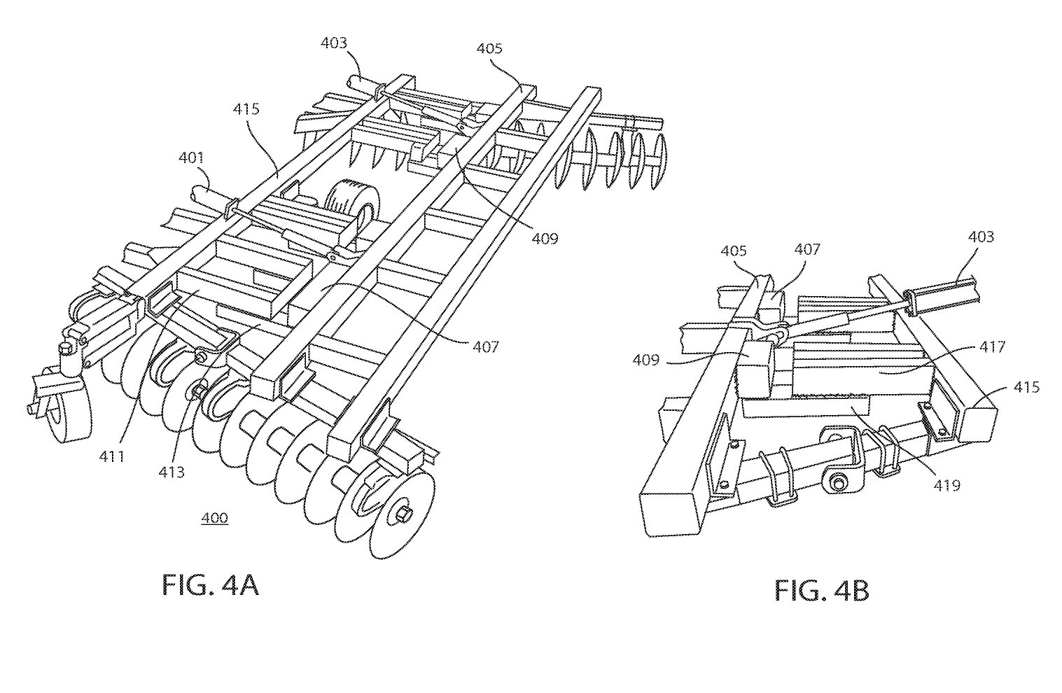

FIG. 3 illustrates a front perspective view showing an improved discing apparatus having bifold wings in accordance with an embodiment of the invention. As seen in FIG. 3, the improved discing apparatus 300 includes a bifold wing assembly 302. Each bifold wing assembly 302 on both sides of the discing apparatus is comprised of an inner beam member 303 and an outer beam member 305 that are joined with brace members 306, 307, 309, 311, 313, 315 and 316. The bifold wing section 302 is connected to spar 318 using the brace members 306, 307, 309, 311. 315 and 316 that act to hold the bifold wing 302 into a structurally fixed position. As will be described herein, a first wing hydraulic piston 317 and second wing hydraulic piston 319 are used in combination with the first main hydraulic piston 321 and second main hydraulic piston 323 for raising the inner wing section and its respective outer wing section in a doubled or bifold manner. As described with regard to FIGS. 4A and 4B, when each of the bifold wing sections 302 are extended and folded outwardly, a series of metallic block like supports 320, 322 are used that are each fastened to a side of the inner beam member 303. These substantially square block supports provide a supporting surface for the inner beam member 303 where it can rest and be fully supported when in an extended position. This arrangement as an advantage in that no wheel need be used outwardly of the wheel assembly 327. In use, the weight of the bifold wing section 302 provides the downward force necessary to maintain the inner beam member 303 against each of the blocks 320, 322 without the use of an additional outward support wheel.

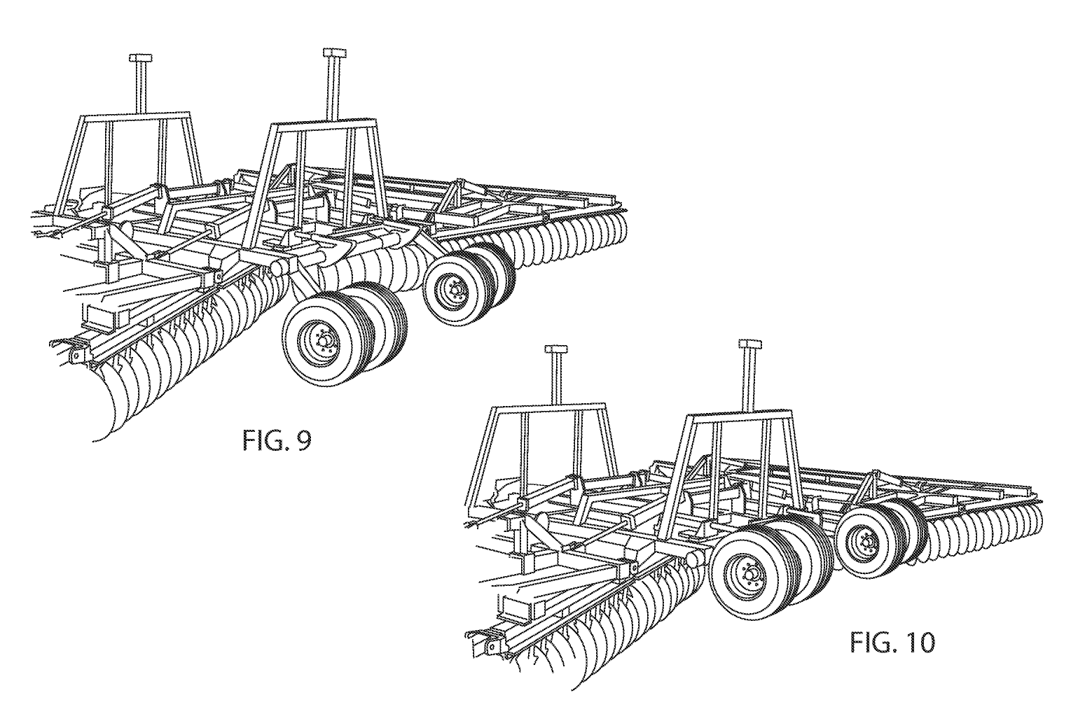

As seen further in FIG. 3, each bifold wing of the discing apparatus 300 is supported using at least two sets of support wheels arranged in a “walking tandem” configuration. More specifically, support wheels 329, 331 and 333, 335 are paired in a manner using a support tube which includes a spindle at each end. The support tube connects to the center section of the disc in a manner so it is pivotable. Each spindle is supported at one end with bearings so as to form a rotating wheel mounting assembly. At both ends of the support tube, the support wheels 329, 331 are paired to provide redundancy for supporting the weight of the discing apparatus 300. As pairs of support wheels 329, 331, and 333, 335 are pivotable they are also self-leveling. As both pairs of support wheels 329, 331 and 333, 335 are positioned in-line behind the other pair, this is generally referred to as a “walking tandem” relationship as one pair walks and/or rolls behind the other. Still another advantage of this arrangement is the transport wheels as shown in FIGS. 9-10 herein are also the same size as wheels 329, 331, 333. 335. This redundancy in size enables the transport wheels to act as spare replacement parts for the support wheels in the walking tandem configuration. As only one transport wheel of each pair is required for transporting the disc while being towed no a roadway, if one of the transport wheels are removed for use as a support wheel, the disc can still be easily transported using one transport wheel on each pair.

As described herein, the “bifold” nature of the discing machine 300 means that the sides and wings both fold upwardly upon themselves along the left and right sides of the discing machine 300. This unique arrangement enables the various furrowing discs, e.g. disc 325, that are positioned both forward and rearward of the discing machine 301, to be longer in length. In this embodiment, the front and rear furrowing discs are in three segments such that the front and rear discs are segmented and angularly positioned in three pieces or sections. As described herein, this allows the discing apparatus to be retracted in a substantially compact and folded state for transport. When in an extended position, the long overall length of the front and rear discs allow a field to be fit more rapidly because of the larger amount of surface area available for covering more acreage as compared to discing machines used in the prior art. Finally, a wheel assembly 327 is used to guide and support the discing apparatus 301 during forward motion.

FIGS. 4A and 4B are opposing perspective views illustrating use of the support blocks as described herein. The wing section 400 illustrates first inner hydraulic piston 401 and second inner hydraulic piston 403, connected with the inner beam member 405 in a manner to allow the wing section to be folded upwardly. As shown in its extended position, the wing section includes a plurality of support blocks. A first support block 407 and second support block 409 at fixedly attached to a side of the inner beam member 405 that faces the center of the discing apparatus. When extended, each of the respective support blocks rest upon a support assembly. For example, support block 407 rests upon a support assembly comprised of an upper support member 411 and lower support member 413. As seen in both FIGS. 4A and 4B, the upper support member 411 forms an H-shape and connects with middle beam member 415. The lower support member 413 attaches under the upper support member 411 and provides a supporting surface for the support block 407. As best seen in FIG. 4B, the second support block 409 includes a similar supporting configuration where an upper support member 417 forms an H-shape and connects with a lower support member 419 that provides a supporting surface for support block 409.

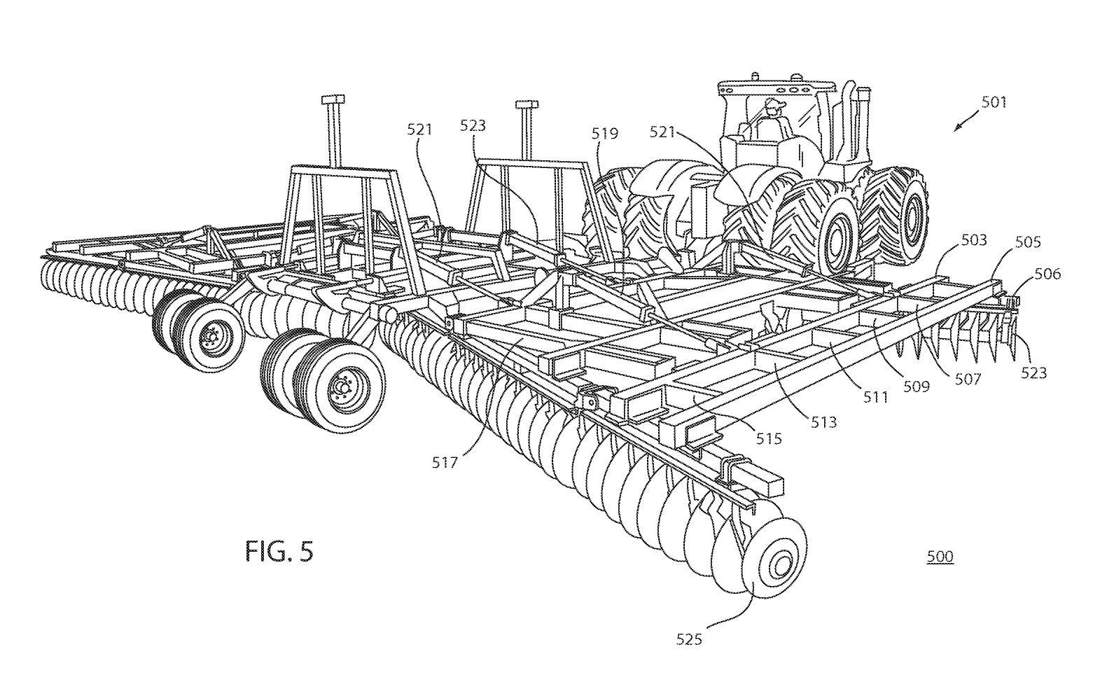

FIG. 5 illustrates a rear perspective view of the discing apparatus. The bifold wing section 501 is shown that comprises inner beam member 503 and outer beam member 505 connected by brace members 506, 507, 509, 511, 513 and 515. Beam member 505 and beam member 503 attach to the main spar 517. As noted herein, the bifold wing section 501 is raised using first outer hydraulic piston 519 and second outer hydraulic piston 521 as well as the first main hydraulic piston 521 and second main hydraulic piston 523 that are used to lift and retract the bifold wing section 501 inwardly toward the center section 101. The front disc 523 and rear disc 525 are shown and are used for digging the planing furrow at a predetermined depth.

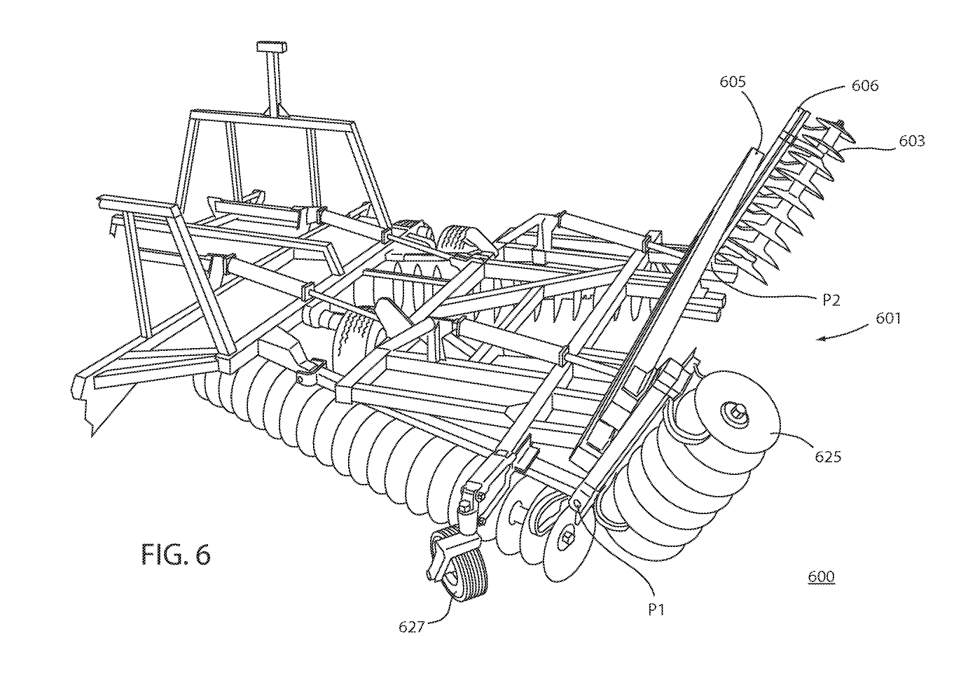

FIG. 6 illustrates a front view of a bifold wing section as shown in FIG. 3 where the bifold wing section is being retracted in accordance with an embodiment of the invention. More specifically, the discing apparatus 600 is shown where the first and second wing hydraulic pistons work to provide a pulling force for pivoting the outer wing about pivot points P1 and P2. This removes the outer winged sections off their respective block supports so the bifold wing section can be retracted for transport.

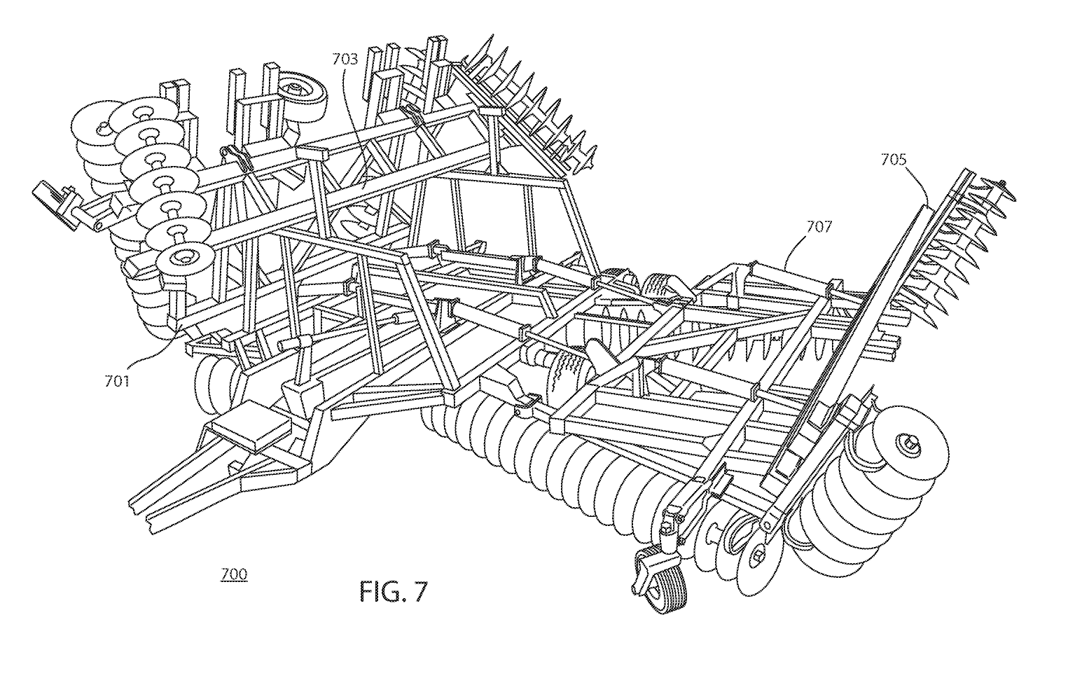

FIG. 7 illustrates a front view of the discing apparatus 700 where both bifold wing sections are partially folded inwardly, toward the center section and toward one another such that in the event of hydraulic failure, the bifolded inner wings and outer wings will collapse inwardly to prevent damage to person or property. More specifically, the inner wing on the left side of the discing apparatus 700 is lifted vertically while the outer wing 703 is shown in a folded position. On the right side of the discing apparatus 700, the inner wing is shown still in an extended position while the outer wing is beginning to fold upwardly. Thus, the folding for transport of the discing apparatus 700 occurs in a predetermined sequence where the right bifold wing assembly will fold initially (outer wing then inner wing) and then the left bifold wing assembly will fold (outer wing then inner wing) in a manner such that the right outer wing is folded under the left outer wing to save maximum space.

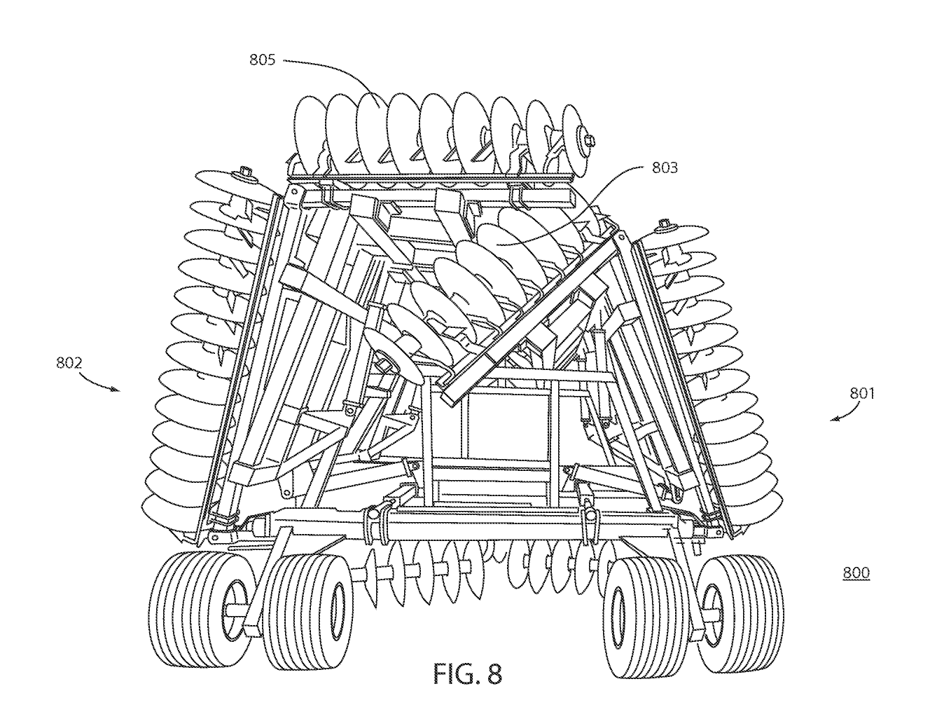

FIG. 8 illustrates a rear view of the discing apparatus where both the bifold wing assemblies are fully folded inwardly, toward the center section, for transport. The first bifold wing assembly 801 and second bifold wing assembly 802 fold in a unique manner to save maximum space since one of the outer wings 803 folds downwardly and inside the other outer wing assembly 805. This keeps the discing apparatus to a minimal height so it can be easily transported without contacting overhanging electrical power wires or telephone lines. Moreover, as seen from the rear view, each of the wing assemblies lean inwardly so that in the event of hydraulic failure, the wing assemblies will collapse inwardly upon themselves.

FIGS. 9 and 10 illustrate a rear view of the transport wheels in a downward and stowed position as used to support the load of the discing apparatus on a roadway. More specially, FIG. 9 shows two sets of outboard wheels that are attached to the rear of the discing apparatus and extend downwardly. These wheels are used for transporting the discing apparatus as well as to better support the tremendous load of the discing apparatus when retraced and traveling on a roadway. Preferably, two sets of wheels are used for load distribution. FIG. 10 shows the wheels in a lifted and/or retracted position where they are positioned off the ground during use in tilling a field. When in use, the front and rear discs contact soil so as to disc the soil thereby rotating the soil underneath itself while creating a furrow for planted seeds or other material.

Thus, an agricultural discing apparatus having bifold wing assemblies includes a center section and a plurality of winged assemblies attached to the center section such that the plurality of winged assemblies includes an inner wing and an outer wing which folds in a bifold manner such that the plurality of winged assemblies fold inwardly when in a retracted position. A first retractable outer wing folds under a second retractable outer wing when in a retracted position so as to prevent the plurality of winged assemblies from moving outwardly in an extended position during transport.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. An agricultural discing apparatus having bifold wing assemblies comprising:
a center section;
a plurality of winged assemblies attached to the center section;
a first plurality of discs positioned on a leading edge of a winged assembly and rotating about a segmented spindle for allowing the first plurality of discs to be broken into segments when retracted;
a second plurality of discs positioned on a trailing edge of the winged assembly and rotating about a segmented spindle for allowing the second plurality of discs to be broken into segments when retracted; and
wherein each of the plurality of winged assemblies includes an inner wing and an outer wing which folds in a bifold manner such that the plurality of winged assemblies fold in an interleaving manner upon themselves when in a retracted position and where the outer wing uses no wheel directly attached to the outer wing to provide support but instead uses a block member attached to the inner wing for supporting the weight of the outer wing.

2. (canceled)

3. (canceled)

4. An agricultural discing apparatus as in claim 1, wherein the plurality of winged sections folds inwardly upon one another when in the retracted position.

5. An agricultural discing apparatus as in claim 1, wherein a plurality of retractable support wheels are attached to the rear of the center section for use in distributing the load of the agricultural discing apparatus in transport.

6. (canceled)

7. (canceled)

8. An agricultural discing apparatus as in claim 1, further comprising:
at least one pair of support wheels positioned centrally to the center section for proving support for the center section during use; and
at least one pair of transport wheels positioned rearwardly of the second plurality of discs for providing support for the disc during transport.

9. An agricultural discing apparatus as in claim 8, wherein the at least one pair of support wheels and at least one pair of transport wheels are the same size so they be used interchangeably.

10. An agricultural discing apparatus for providing discing and vertical tillage in a field comprising:
a center section;
a plurality of winged assemblies attached to the center section;
a first separable disc rotating about a spindle positioned in front of the center section and plurality winged assemblies that separates into segments when retracted;
a second separable disc rotating about a spindle positioned behind the center section and plurality winged assemblies that separates into segments when retracted; and
wherein each of the plurality of winged assemblies includes a retractable inner wing and a retractable outer wing extending outwardly of the center section when in an extended position and operable to fold in a bifold manner such that the plurality of winged assemblies interleave by folding upon themselves when moved into a retracted position and where the outer wing uses no wheel directly attached to the outer wing to provide support but instead uses a block member attached to the inner wing for supporting the weight of the outer wing.

11. (canceled)

12. (canceled)

13. An agricultural discing apparatus as in claim 10, wherein the plurality of winged assemblies folds inwardly upon one another when in the retracted position.

14. An agricultural discing apparatus as in claim 10, further comprising:
a plurality of support wheels positioned under the center section for supporting the agricultural discing apparatus during discing operation; and
a plurality of transport wheels attached to the rear of the center section for use in distributing the load of the agricultural discing apparatus in transport.

15. An agricultural discing apparatus as in claim 14, wherein the plurality of support wheels and plurality of transport wheels are the same size so they may be interchanged to effectuate repair in the event of a flat tire.

16. An agricultural discing apparatus as in claim 10, wherein the plurality of winged assemblies folds inwardly upon themselves in order to prevent the plurality of winged assemblies from tipping during transport.

17. An agricultural discing apparatus having bifold wing assemblies comprising:
a center section;
a first plurality of discs positioned on a leading edge of a winged assembly and rotating about a segmented spindle for allowing the first plurality of discs to be broken into segments when retracted;
a second plurality of discs positioned on a trailing edge of the winged assembly and rotating about a segmented spindle for allowing the second plurality of discs to be broken into segments when retracted; and
a plurality of winged assemblies attached to the center section such that the plurality of winged assemblies includes an inner wing and an outer wing which folds in a bifold manner such that the plurality of winged assemblies are interleaved when in a retracted position; and
wherein a first retractable outer wing folds under a second retractable outer wing when in a retracted position in order to prevent the plurality of winged assemblies from moving outwardly towards an extended position during transport and where the outer wing uses no wheel directly attached to the outer wing to provide support but instead uses a block member attached to the inner wing for supporting the weight of the outer wing.

18. (canceled)

19. (canceled)

20. An agricultural discing apparatus as in claim 17, wherein a plurality of support wheels under the center section can be used interchangeably to effectuate repair in the event of a flat tire.
